(19) United States
(12) Patent Application Publication
(10) Pub. No.: US 2025/0371140 A1
(43) Pub. Date: Dec. 4, 2025

(54) MODEL AUTHENTICITY EVALUATION METHODS, APPARATUSES, AND DEVICES

(71) Applicant: Alipay (Hangzhou) Information Technology Co., Ltd., Hangzhou (CN)

(72) Inventors: Yangwei WEI, Hangzhou (CN); Shiwen CUI, Hangzhou (CN); Zhuoer XU, Hangzhou (CN); Zhangxuan GU, Hangzhou (CN); Changhua MENG, Hangzhou (CN); Chuanliang SUN, Hangzhou (CN); Weiqiang WANG, Hangzhou (CN)

(21) Appl. No.: 19/218,618

(22) Filed: May 27, 2025

(30) Foreign Application Priority Data
Jun. 3, 2024 (CN) 202410714466.1

(51) Int. Cl. G06F 21/55; G06F 40/20

(52) U.S. Cl. CPC G06F 21/552; G06F 40/20

(57) ABSTRACT

Embodiments of this specification disclose model authenticity evaluation methods, apparatuses, and devices. The method includes: obtaining first question data used to perform authenticity evaluation on a target model, and inputting the first question data to a target model to obtain a first response result corresponding to the first question data; extracting a named entity included in the first question data, and constructing second question data based on the named entity and the first question data, where the second question data is used to trigger the target model to output an analysis basis and a result for the first question data; inputting the second question data to the target model to obtain a model prediction result corresponding to the second question data; and determining an authenticity evaluation result of the target model based on the first response result and the model prediction result.

### TECHNICAL FIELD

This specification relates to the field of computer technologies, and in particular, to model authenticity evaluation methods, apparatuses, and devices.

### BACKGROUND

As people pay more and more attention to their privacy data, to protect user privacy and ensure data security, corresponding models are run in many services to provide related services. Currently, various models (especially large models) are emerging every day. Before a model is put into large-scale use, whether the model is reliable and whether a result output by the model conforms to a fact or is contrary to world knowledge is very important. A corresponding technical problem behind this is model hallucination detection, that is, model authenticity evaluation. On the one hand, an effective model authenticity evaluation mechanism (or model hallucination detection mechanism) can effectively guarantee authenticity of a result output by a model. On the other hand, if model authenticity cannot be effectively evaluated (or if model hallucination cannot be effectively detected), and numerous authenticity problems are exposed by the public only after the model is released to the outside, highly detrimental impact is generated. Therefore, a better technical solution for model authenticity evaluation needs to be provided.

### SUMMARY

An objective of embodiments of this specification is to provide a better technical solution for model authenticity evaluation, to not only make it easier to construct a dataset, but also avoid occurrence of quality defects caused by a lack of a capability of a detection module and poor detection quality caused by low quality of question-answer data are not generated. In addition, because the technical solution does not depend on discrete static question-answer data or depend on a data-driven detection tool, a problem of sparse coverage scenarios does not occur. Moreover, the technical solution not only can be applied to an online real-time environment, but also can implement dynamic detection, thereby greatly improving efficiency and performance of model authenticity evaluation.

To implement the above-mentioned technical solution, the embodiments of this specification are implemented as follows:

One or more embodiments of this specification provide a model authenticity evaluation method. The method includes: obtaining first question data used to perform authenticity evaluation on a target model, and inputting the first question data to the target model to obtain a first response result corresponding to the first question data; extracting a named entity included in the first question data, and constructing second question data based on the named entity and the first question data, where the second question data is used to trigger the target model to output an analysis basis and a result for the first question data; inputting the second question data to the target model to obtain a model prediction result corresponding to the second question data, where the model prediction result includes analysis basis information obtained by analyzing the first question data and a second response result corresponding to the first question data; and determining an authenticity evaluation result of the target model based on the first response result and the model prediction result.

One or more embodiments of this specification provide a model authenticity evaluation apparatus. The apparatus includes: a first result determining module, configured to obtain first question data used to perform authenticity evaluation on a target model, and input the first question data to the target model to obtain a first response result corresponding to the first question data; a data transformation module, configured to extract a named entity included in the first question data, and construct second question data based on the named entity and the first question data, where the second question data is used to trigger the target model to output an analysis basis and a result for the first question data; a second result determining module, configured to input the second question data to the target model to obtain a model prediction result corresponding to the second question data, where the model prediction result includes analysis basis information obtained by analyzing the first question data and a second response result corresponding to the first question data; and an evaluation module, configured to determine an authenticity evaluation result of the target model based on the first response result and the model prediction result.

One or more embodiments of this specification provide a model authenticity evaluation device. The model authenticity evaluation device includes: a processor, and a memory configured to store computer-executable instructions. When the executable instructions are executed, the processor is enabled to perform the following operations: obtaining first question data used to perform authenticity evaluation on a target model, and inputting the first question data to the target model to obtain a first response result corresponding to the first question data; extracting a named entity included in the first question data, and constructing second question data based on the named entity and the first question data, where the second question data is used to trigger the target model to output an analysis basis and a result for the first question data; inputting the second question data to the target model to obtain a model prediction result corresponding to the second question data, where the model prediction result includes analysis basis information obtained by analyzing the first question data and a second response result corresponding to the first question data; and determining an authenticity evaluation result of the target model based on the first response result and the model prediction result.

One or more embodiments of this specification further provide a storage medium. The storage medium is configured to store computer-executable instructions. When the executable instructions are executed by a processor, the following procedure is implemented: obtaining first question data used to perform authenticity evaluation on a target model, and inputting the first question data to the target model to obtain a first response result corresponding to the first question data; extracting a named entity included in the first question data, and constructing second question data based on the named entity and the first question data, where the second question data is used to trigger the target model to output an analysis basis and a result for the first question data; inputting the second question data to the target model to obtain a model prediction result corresponding to the second question data, where the model prediction result includes analysis basis information obtained by analyzing the first question data and a second response result corresponding to the first question data; and determining an authenticity evaluation result of the target model based on the first response result and the model prediction result.

One or more embodiments of this specification further provide a computer program product including a computer program. When the computer program is executed by a processor, the following procedure is implemented: obtaining first question data used to perform authenticity evaluation on a target model, and inputting the first question data to the target model to obtain a first response result corresponding to the first question data; extracting a named entity included in the first question data, and constructing second question data based on the named entity and the first question data, where the second question data is used to trigger the target model to output an analysis basis and a result for the first question data; inputting the second question data to the target model to obtain a model prediction result corresponding to the second question data, where the model prediction result includes analysis basis information obtained by analyzing the first question data and a second response result corresponding to the first question data; and determining an authenticity evaluation result of the target model based on the first response result and the model prediction result.

### BRIEF DESCRIPTION OF DRAWINGS

To describe the technical solutions in the embodiments of this specification or in an existing technology more clearly, the following briefly describes the accompanying drawings needed for describing the embodiments or the existing technology. Clearly, the accompanying drawings in the following descriptions merely show some embodiments of this specification, and a person of ordinary skill in the art can still derive other drawings from these accompanying drawings without creative efforts.

FIG. 1 is a schematic diagram illustrating a model authenticity evaluation process, according to this specification;

FIG. 2 is a schematic diagram illustrating another model authenticity evaluation process, according to this specification;

FIG. 3 illustrating an embodiment of a model authenticity evaluation method, according to this specification;

FIG. 4 is a schematic diagram illustrating still another model authenticity evaluation process, according to this specification;

FIG. 5 illustrating another embodiment of a model authenticity evaluation method, according to this specification;

FIG. 6 is a schematic diagram illustrating still another model authenticity evaluation process, according to this specification;

FIG. 7 illustrating still another embodiment of a model authenticity evaluation method, according to this specification;

FIG. 8 is a schematic diagram illustrating still another model authenticity evaluation process, according to this specification;

FIG. 9 illustrating an embodiment of a model authenticity evaluation apparatus, according to this specification; and

FIG. 10 illustrating an embodiment of a model authenticity evaluation device, according to this specification;

### DESCRIPTION OF EMBODIMENTS

Embodiments of this specification provide model authenticity evaluation methods, apparatuses, and devices.

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiments of this specification without creative efforts shall fall within the protection scope of this specification.

One or more embodiments of this specification provide a model authenticity evaluation mechanism. Model authenticity evaluation is mainly to determine whether a “hallucination” problem, especially a large model hallucination problem, exists in a current model. Model hallucination can occur when an output result generated by a model does not follow an original text (Faithfulness) or does not conform to a fact (Factualness). In this case, it can be considered that a hallucination problem exists in the model. Currently, various models (especially large models) are emerging every day. Before a model is put into large-scale use, whether the model is reliable and whether a result output by the model conforms to a fact or is contrary to world knowledge is very important. A corresponding technical problem behind this is model hallucination detection, that is, model authenticity evaluation. On the one hand, an effective model authenticity evaluation mechanism (or model hallucination detection mechanism) can effectively guarantee authenticity of a result output by a model. On the other hand, if model authenticity cannot be effectively evaluated (or if model hallucination cannot be effectively detected), and numerous authenticity problems are exposed by the public only after the model is released to the outside, highly detrimental impact is generated.

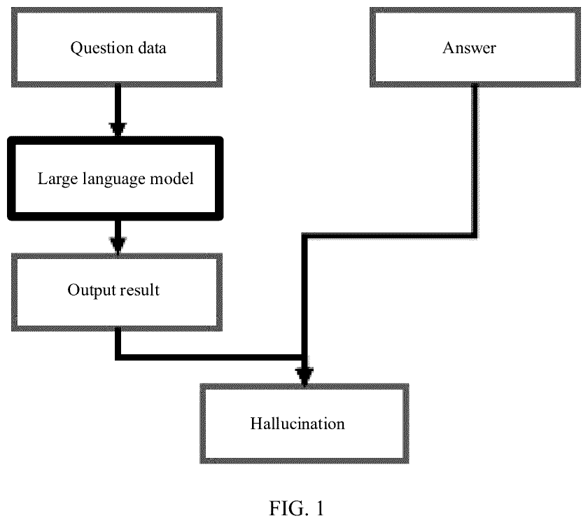

There can be two commonly used evaluation methods. A first method is based on static question-answer data. As shown in FIG. 1, a static question-answer dataset can be constructed manually or generated based on a model. Static question-answer data in the static question-answer dataset can be as follows: Question data: On XX/XX/20XX, who defeated the incumbent president KKK, who was running for re-election, and successfully elected the president of Country A? Answer data: BBB. Question data in the static question-answer data can be input to a large language model (LLM), and then evaluation is performed based on an output result of the large language model (LLM) in combination with answer data in the static question-answer data, to determine whether a hallucination exists in the model. Afterwards, a correct rate can be counted. However, in the above-mentioned method, a problem of difficulty in constructing the static question-answer dataset exists. Specifically, if the static question-answer dataset is constructed manually, costs are very high. If the static question-answer data is generated by using a model, a large model needs to be separately trained or fees are directly paid to use a commercial large model, but relatively high dataset construction costs are involved. In addition, there may also be a problem that quality is difficult to control. Specifically, for the method of generating the static question-answer data by using a model, the model itself also involves a hallucination problem, which makes it difficult to control quality of a generated dataset. Moreover, a problem of sparsity coverage scenarios may also exist. Specifically, a magnitude of the static question-answer dataset is ultimately limited, and it is difficult to exhaust all possibilities. Therefore, detection can only be targeted at sparse typical scenarios, and it is difficult to cover some low-frequency long-tail scenarios. Furthermore, there may also be a problem that it is difficult to dynamically update the static question-answer dataset. Specifically, a feature of the static question-answer dataset causes a static evaluation method, and dynamically updating the question-and-answer dataset is difficult to implement due to a cost problem.

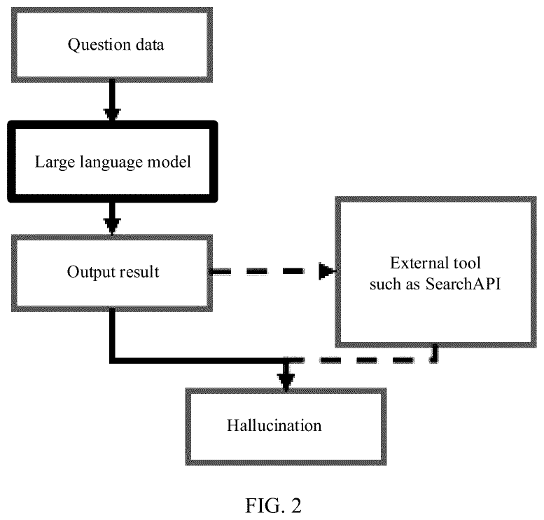

In a second method, hallucination detection is performed on a model by using an external tool. As shown in FIG. 2, for any offline or real-time dynamically input question data, a corresponding output result can be obtained after the question data passes through a large language model. Then, a retrieval tool (such as SearchAPI), a knowledge graph, or another large language model (LLM) needs to be further used to perform hallucination detection on the output result. However, in the above-mentioned method, the external tool used has a performance bottleneck. In one aspect, the retrieval tool or the knowledge graph is mainly driven by an algorithm and data, but data may be sparse, for example, the knowledge graph does not cover the data or a related result cannot be retrieved, which may lead to a failure of the hallucination detection solution. In another aspect, if hallucination detection is performed by using another large language model (LLM), the solution fails because the another large language model (LLM) may also have a hallucination problem. Therefore, embodiments of this specification provide a better technical solution for model authenticity evaluation. In the technical solution, not only a dataset is more easily constructed, but also occurrence of quality defects caused by a lack of a capability of a detection module and poor detection quality caused by low quality of question-answer data are avoided. In addition, because the technical solution does not depend on discrete static question-answer data or depend on a data-driven detection tool, a problem of sparse coverage scenarios does not exist. Moreover, the technical solution not only can be applied to an online real-time environment, but also can implement dynamic detection, thereby greatly improving efficiency and performance of model authenticity evaluation. For specific processing, references can be made to specific content in the following embodiments.

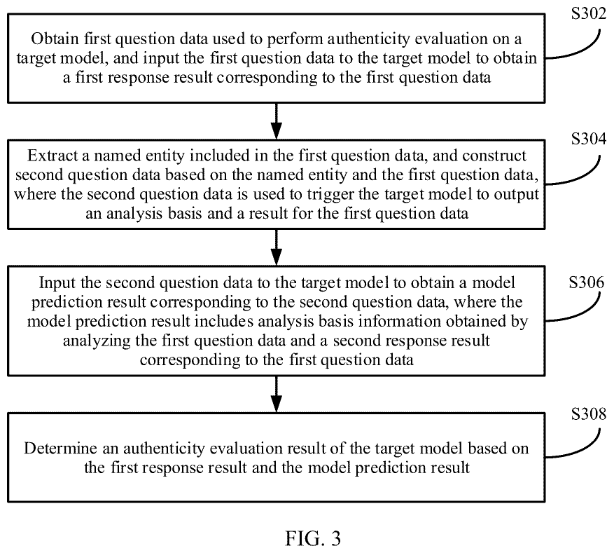

As shown in FIG. 3, one or more embodiments of this specification provide a model authenticity evaluation method. An execution entity of the method can be a terminal device, a server, etc. The terminal device can be a mobile terminal device such as a mobile phone or a tablet computer, or can be a computer device such as a notebook computer or a desktop computer, or can be an IoT device (such as a smart watch or an in-vehicle device). The server can be an independent server, or can be a server cluster including a plurality of servers, etc. The server can be a background server of a financial service, a network shopping service, etc., or can be a background server of an application program. In the one or more embodiments, that the execution entity is a server is used as an example for detailed description. For a case that the execution entity is a terminal device, references can be made to the following server case for processing. Details are omitted for simplicity here. The method can specifically include the following steps:

In step S302, first question data used to perform authenticity evaluation on a target model is obtained, and the first question data is input to a target model to obtain a first response result corresponding to the first question data.

The target model can be any model. Specifically, for example, the target model can be a convolutional neural network model or a deep neural network model. The target model can alternatively be a large model (including a generative large model and a discriminative large model). In the one or more embodiments, the target model can be a model that can give a corresponding answer to input question data, that is, can be a model applied to a human-computer interaction scenario such as a human-computer question answering scenario or a human-computer dialogue scenario, specifically, for example, a large language model. The first question data can be any question data. The first question data can be text data directly input by a user, or can be audio data or voice data provided by a user, for example, “Are account A and account B the same user's account?”, “Is the user named A the same person as the user named B?”, or “What is a large language model?”. The first question data can be specifically set based on an actual situation. In actual application, the first question data can alternatively include not only question-based data, which is specifically as the above-mentioned example, but also non-question-based data, specifically, for example, “I want to watch a movie” or “I have a fever, please recommend some prescriptions”. The first question data can be specifically set based on an actual situation, and is not limited in the one or more embodiments of this specification. The first response result can be result data of response content or reply to a question (or query) corresponding to the first question data. For example, the first question data is “Are account A and account B the same user's account?”, the first response result can be “Account A and account B are the same user's account, because account A and Account B are authenticated by using the same identity card.” For another example, the first question data is “I have a fever, please recommend some prescriptions”, and the first response result can be “If you have a fever, it is recommended that you consult a doctor in time, and the doctor prescribes a prescription suitable for you based on your specific situation. The following are some commonly used Chinese medicine prescriptions for your reference: 1. Guizhi Decoction: suitable for cold-induced fever, headache . . . ”. It is worthwhile to note that, the first response result output by the target model does not necessarily always conform to a fact, and may not conform to a fact or is contrary to world knowledge. For example, the first question data is “Are Fanqie and Xihongshi the same plant?”, and the first response result can be: “Fanqie and Xihongshi are different plants, they are not the same plant.” In this case, a hallucination problem occurs in the model.

In implementation, the first question data used to perform authenticity evaluation on the target model can be obtained in a plurality of different methods. For example, authenticity evaluation personnel can directly input text data or voice data of the first question data; or an evaluation database can be pe-constructed, where the evaluation database can include a plurality of pieces of different question data, and the evaluation personnel can select one or more pieces of question data from the evaluation database, and the selected question data can be used as the first question data used to perform authenticity evaluation on the target model; or question data provided by volunteers can be collected through an invitation or paid evaluation, and the collected question data can be used as the first question data used to perform authenticity evaluation on the target model; or published public data can be collected through a network, and valid question data (that is, question data that can be used to perform authenticity evaluation on the target model) in the public data can be used as the first question data. A method can be specifically set based on an actual situation, and is not limited in the one or more embodiments of this specification.

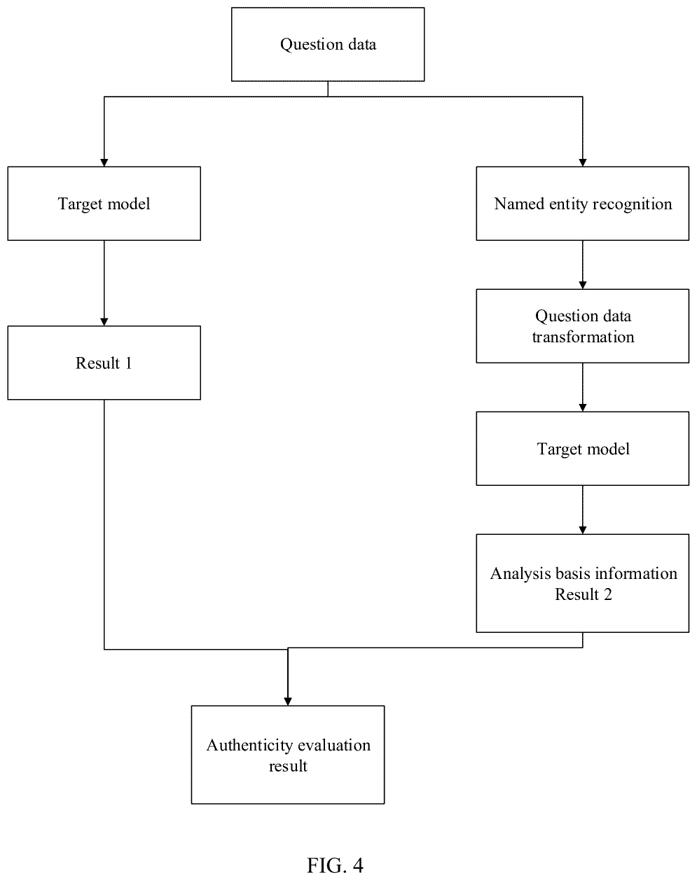

As shown in FIG. 4, after the first question data is obtained in the above-mentioned method, the first question data can be input to the target model. If the first question data is text data, the text data can be directly input to the target model. If the first question data is audio data or voice data, and the target model allows direct input of the audio data or the voice data, the first question data of the audio data or the voice data can be directly input to the target model. The target model can perform voice recognition on the first question data to obtain semantic information corresponding to the first question data or obtain text data corresponding to the first question data. Then, the target model can perform subsequent processing based on the obtained semantic information or text data. If the first question data is audio data or voice data, but the target model does not support direct input of the audio data or the voice data, the first question data of the audio data or the voice data can be directly converted into text data, and the text data obtained through conversion can be input to the target model. After receiving the first question data, the target model can perform one or more of the following processing on the first question data: feature extraction, vectorization processing, feature matching, and answer generation, to finally obtain a corresponding output result. The output result can be used as a replay (or an answer, a response, or a query result) to a question corresponding to the first question data, to obtain the first response result corresponding to the first question data.

In step S304, a named entity included in the first question data is extracted, and second question data is constructed based on the named entity and the first question data, where the second question data is used to trigger the target model to output an analysis basis and a result for the first question data.

The named entity can be an entity identified by a name. For example, the named entity can include names of people, institutions, and places, addresses, measures, percentages, numbers (including cardinal numbers), dates, currencies, and other entities identified by names.

In implementation, to verify whether the first response result output by the target model conforms to a fact, the target model can continue to be used for processing. However, before the target model is used, the first question data needs to be transformed. Specifically, as shown in FIG. 4, to detect, in more detail, whether the target model has sufficient recognition of the named entity in the first question data, the named entity included in the first question data can be detected, and the detected named entity can be extracted from the first question data. The above-mentioned detection and extraction of the named entity can be implemented in a plurality of different methods. For example, a detection algorithm and an extraction algorithm for the named entity can be preset, the named entity included in the first question data can be detected by using the detection algorithm, and the detected named entity can be extracted from the first question data by using the extraction algorithm. Alternatively, the named entity can be detected and extracted by using a pre-trained specified model. Specifically, a long short-term memory (LSTM) model can be constructed to detect and extract the named entity, or a BERT model can be constructed to detect and extract the named entity, which can be specifically set based on an actual situation, and is not limited in the one or more embodiments of this specification. For example, the first question data is “Are Fanqie and Xihongshi the same plant?”, and through the above-mentioned algorithm or model, the named entity that can be extracted from the first question data includes “Fanqie” and “Xihongshi”.

As shown in FIG. 4, after a key named entity in the first question data is recognized in the above-mentioned method, the first question data can be transformed. Specifically, a transformation rule can be preset, and there can be a plurality of transformation rules. For example, the transformation rule can be as follows: Each named entity is explained, and an answer to a question corresponding to the first question data is given based on content of the explanation. Alternatively, the transformation rule can be as follows: Each named entity is explained, similarities and differences between different named entities are analyzed and listed, and an answer to a question corresponding to the first question data is given based on content of the explanation and the similarities and differences obtained through analysis. Specifically, the transformation rule can alternatively be set based on an actual situation. This is not limited in the one or more embodiments of this specification. Corresponding new question data (that is, the second question data) can be generated based on the named entity and the first question data by using the above-mentioned transformation rule. For example, the transformation rule can be as follows: Each named entity is explained, and an answer to a question corresponding to the first question data is given based on content of the explanation. The second question data obtained through the transformation rule can be “Please introduce or explain Fanqie and Xihongshi, and then give an answer to the question “Are Fanqie and Xihongshi the same plant?” based on content of the explanation?”. Specific content, for example, explaining each named entity or analyzing and listing similarities and differences between different named entities, can be used as the analysis basis for the first question data, and the answer given to the question corresponding to the first question data can be used as the result for the first question data. Through the above transformation of the first question data, the new question data can detect, from a plurality of aspects, recognition and understanding of the first question data by the target model, thereby facilitating authenticity evaluation of the target model.

In step S306, the second question data is input to the target model to obtain a model prediction result corresponding to the second question data, where the model prediction result includes analysis basis information obtained by analyzing the first question data and a second response result corresponding to the first question data.

In implementation, as shown in FIG. 4, after the new second question data is reconstructed in the above-mentioned method, the second question data can be input to the target model, and the target model processes the second question data to obtain the model prediction result of the target model for the second question data, so that the analysis basis information obtained by analyzing the first question data and the second response result corresponding to the first question data can be obtained. For example, the second question data can be “Please introduce or explain Fanqie and Xihongshi, and then give an answer to the question “Are Fanqie and Xihongshi the same plant?” based on content of the explanation?”. The corresponding model prediction result can include the following: “1. Fanqie is an annual herbaceous plant of the Solanaceae family, with a plant height of 2 meters. It is native to South America and was originally a wild berry in South America. People believe that it's brightly colored and is highly poisonous, and is only used for viewing . . . . 2. Xihongshi, also known as Fanqie, is native to Peru and Mexico. It was originally called “wolf peach”. The fruit is rich in nutrients and has a special flavor. It can be eaten raw, cooked, processed into tomato sauce or juice, or canned as a whole fruit, etc. 3. Fanqie and Xihongshi are not the same plant.” The part “1” and the part “2” in the above-mentioned model prediction result can be the analysis basis information obtained by analyzing the first question data, and the part “3” in the above-mentioned model prediction result is the second response result corresponding to the first question data.

In step S308, an authenticity evaluation result of the target model is determined based on the first response result and the model prediction result.

In implementation, as shown in FIG. 4, the first response result can be matched with the second response result in the model prediction result (for example, matching can be performed through similarity calculation or through keyword comparison). If the first response result matches the second response result, it can be determined that the target model succeeds in authenticity evaluation, that is, it can be considered that the target model does not have a hallucination problem. If the first response result does not match the second response result, it can be determined that the target model fails in authenticity evaluation, that is, it can be considered that the target model has a hallucination problem. Alternatively, the first response result can be matched with the analysis basis information in the model prediction result (for a specific matching method, references can be made to the above-mentioned content). If the first response result matches the analysis basis information, it can be determined that the target model succeeds in authenticity evaluation, that is, it can be considered that the target model does not have a hallucination problem. If the first response result does not match the analysis basis information, it can be determined that the target model fails in authenticity evaluation, that is, it can be considered that the target model has a hallucination problem. Alternatively, the above-mentioned two methods can be combined to jointly determine the authenticity evaluation result of the target model. A method can be specifically set based on an actual situation, and is not limited in the one or more embodiments of this specification.

It is worthwhile to note that the target model used in step S306 can be the same as the target model used in step S302. In actual application, the target model used in step S306 can alternatively be different from the target model used in step S302. The target model in step S302 can be a model on which authenticity evaluation needs to be performed, and the target model in step S306 can be another model that has a same function or effect as the target model and does not have a hallucination problem. For example, the target model in step S302 can be a large language model (LLM), and the target model in step S306 can be another large language model (LLM) (the large language model (LLM) does not have a hallucination problem). The target model can be specifically set based on an actual situation, and is not limited in the one or more embodiments of this specification.

The one or more embodiments of this specification provide a model authenticity evaluation method. First question data used to perform authenticity evaluation on a target model is obtained, and the first question data is input to the target model to obtain a first response result corresponding to the first question data. In addition, a named entity included in the first question data is extracted, and second question data is constructed based on the named entity and the first question data. Then, the second question data can be input to the target model to obtain a model prediction result corresponding to the second question data, where the model prediction result includes analysis basis information obtained by analyzing the first question data and a second response result corresponding to the first question data. Finally, an authenticity evaluation result of the target model can be determined based on the first response result and the model prediction result. In this way, the target model is used to check authenticity of the target model. For different query methods of same question data, if there is a contradiction between two results given by the target model, it can be determined that the target model has a hallucination. In addition, the solution does not depend on a pair of question-answer datasets. Therefore, any question data can be used as the first question data, so that it is easier to construct a dataset. Moreover, in the solution, the target model can be used to check itself, so that quality defects caused by a lack of a capability of a detection module do not occur, and poor detection quality caused by low quality of a question-answer dataset does not occur. Further, the solution does not depend on a discrete static dataset or depend on a data-driven detection tool (such as a knowledge graph or a retrieval tool), a so that a problem of sparse coverage scenarios does not occur. Moreover, the solution not only can be applied to an online real-time environment, but also can implement dynamic detection, thereby greatly improving efficiency and performance of model authenticity evaluation.

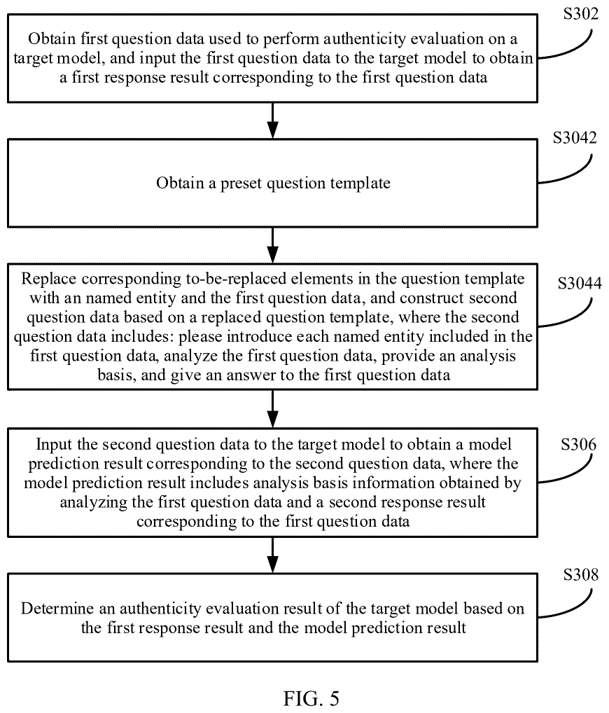

In actual application, there can be various specific processing methods of constructing the second question data based on the named entity and the first question data in step S304. The following provides an optional processing method. As shown in FIG. 5, the processing method can specifically include the following step S3042 and step S3044.

In step S3042, a preset question template is obtained.

In implementation, there can be various question templates. For example, the question template can be as follows: Please first introduce Entity-1, Entity-2, . . . , and Entity-n, then give an analysis basis for question data Query1, and finally give an answer to the question data Query1, where Entity-1, Entity-2, . . . , and Entity-n can be used to indicate n different named entities, and Query1 represents question data (for example, the first question data) of a question that needs to be queried or answered. In actual application, in addition to the above-mentioned question template, another similar question template can be constructed. For another example, the question template can be as follows: Please first introduce Entity-1, Entity-2, . . . , and Entity-n, then give an analysis basis for question data Query1, and finally give an answer to the question data Query1, for example, input: Query-sample, and output: Response-sample, where Query-sample represents a query sample (or question data), and Response-sample represents a response sample (or response result). Typical samples can be selected for the above-mentioned “input” and “output” based on different target models, which can be specifically set based on an actual situation, and is not limited in the one or more embodiments of this specification.

In step S3044, the named entity and the first question data are used to replace corresponding to-be-replaced elements in the above-mentioned question template, and the second question data is constructed based on a replaced question template, where the second question data includes: please introduce each named entity included in the first question data, analyze the first question data, provide an analysis basis, and give an answer to the first question data.

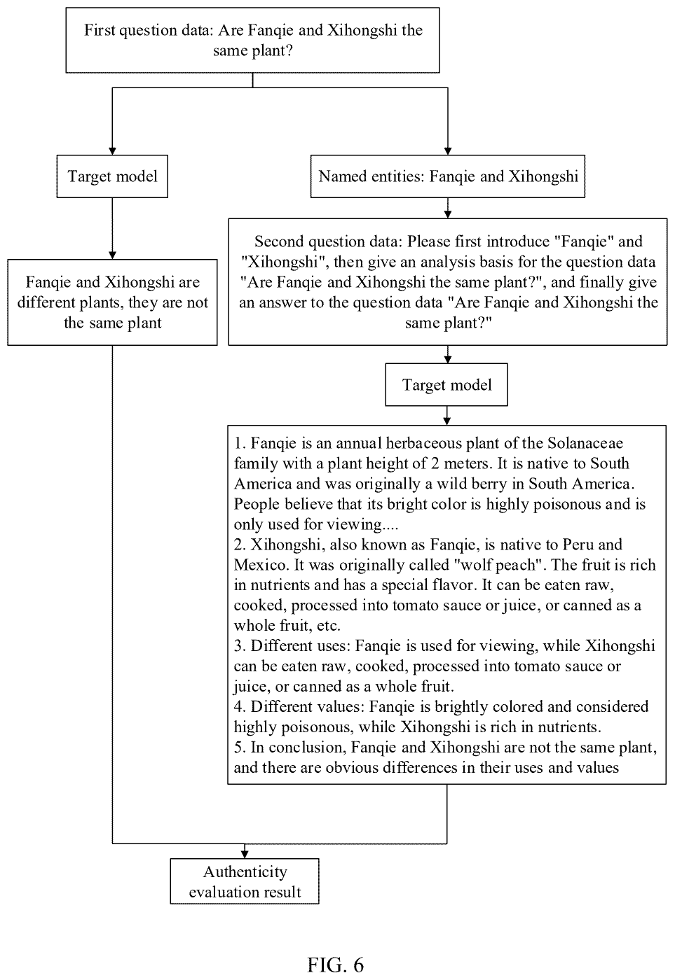

In implementation, after the named entity is obtained in the above-mentioned method, the obtained named entity can be used to replace a corresponding to-be-replaced element in the above-mentioned question template. For example, as shown in FIG. 6, the question template can be as follows: Please first introduce Entity-1, Entity-2, . . . , and Entity-n, then give an analysis basis for question data Query1, and finally give an answer to the question data Query1. The first question data is “Are Fanqie and Xihongshi the same plant?”, where named entities included in the first question data include “Fanqie” and “Xihongshi”. Therefore, the named entities “Fanqie” and “Xihongshi” in the first question data can be used to replace “Entity-1, Entity-2, . . . , and Entity-n” in the above-mentioned question template. Similarly, the first question data “Are Fanqie and Xihongshi the same plant?” can be used to replace “Query1” in the above-mentioned question template. Finally, a replaced question template is changed to “Please first introduce “Fanqie” and “Xihongshi”, then give an analysis basis for the question data “Are Fanqie and Xihongshi the same plant?”, and finally give an answer to the question data “Are Fanqie and Xihongshi the same plant?””. The replaced question template can be used as the second question data, or other necessary descriptions or examples (such as “for example, input: Query-sample, and output: Response-sample” in the above-mentioned question template) or other related information can be added to the replaced question template, which can be specifically set based on an actual situation.

Based on the second question data in the above-mentioned example, the second question data can be input to the target model to obtain the model prediction result corresponding to the second question data. As shown in FIG. 6, the model prediction result can include the following: “1. Fanqie is an annual herbaceous plant of the Solanaceae family, with a plant height of 2 meters. It is native to South America and was originally a wild berry in South America. People believe that its bright color is highly poisonous and is only used for viewing . . . . 2. Xihongshi, also known as Fanqie, is native to Peru and Mexico. It was originally called “wolf peach”. The fruit is rich in nutrients and has a special flavor. It can be eaten raw, cooked, processed into tomato sauce or juice, or canned as a whole fruit, etc. 3.

Different uses: Fanqie is used for viewing, while Xihongshi can be eaten raw, cooked, processed into tomato sauce or juice, or canned as a whole fruit. 4. Different values: Fanqie is brightly colored and considered highly poisonous, while Xihongshi is rich in nutrients. 5. In conclusion, Fanqie and Xihongshi are not the same plant, and there are obvious differences in their uses and values.” The above-mentioned “1. Fanqie is an annual herbaceous plant of the Solanaceae family, with a plant height of 2 meters. It is native to South America and was originally a wild berry in South America. People believe that its bright color is highly poisonous and is only used for viewing . . . . 2. Xihongshi, also known as Fanqie, is native to Peru and Mexico. It was originally called “wolf peach”. The fruit is rich in nutrients and has a special flavor. It can be eaten raw, cooked, processed into tomato sauce or juice, or canned as a whole fruit, etc. 3. Different uses: Fanqie is used for viewing, while Xihongshi can be eaten raw, cooked, processed into tomato sauce or juice, or canned as a whole fruit. 4. Different values: Fanqie is brightly colored and considered highly poisonous, while Xihongshi is rich in nutrients.” can be belong to the analysis basis for analyzing the first question data. “5. In conclusion, Fanqie and Xihongshi are not the same plant, and there are obvious differences in their uses and values” can belong to the second response result.

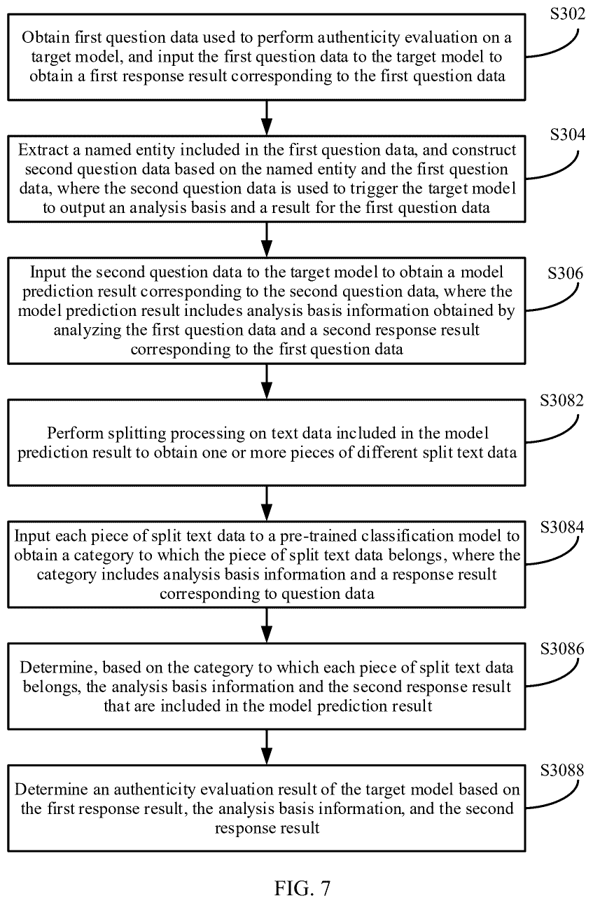

In actual application, there can be various specific processing methods of step S308. The following provides an optional processing method. As shown in FIG. 7, the processing method can specifically include the following step S3082 to step S3088.

In step S3082, splitting processing is performed on text data included in the model prediction result to obtain one or more pieces of different split text data.

In implementation, because the model prediction result includes the analysis basis information and the second response result, to better distinguish which information belongs to the analysis basis information and which result belongs to the second response result, splitting processing can be performed on complete content of the text data included in the model prediction result. Specifically, splitting processing can be performed in a plurality of different methods. For example, the above-mentioned text data can be split based on semantic information of the text data, or the above-mentioned text data can be split based on a specified type of symbol (such as a period, a question mark, an exclamation mark, or a separator) in the text data. In addition, splitting processing can alternatively be performed in another method. For example, splitting processing can be performed by using a specified splitting algorithm or a pre-trained model (such as a neural network model). A method can be specifically set based on and actual situation, and is not limited in the one or more embodiments of this specification. One or more pieces of different split text data can be obtained through the above-mentioned splitting processing.

In step S3084, each piece of split text data is input to a pre-trained classification model to obtain a category to which the piece of split text data belongs, where the category includes analysis basis information and a response result corresponding to question data.

The classification model can be constructed in a plurality of different methods. For example, the classification model can be constructed by using a neural network model, or can be constructed by using a specified classification algorithm such as a random forest algorithm or a binary tree algorithm. A method can be specifically set based on an actual situation, and is not limited in the one or more embodiments of this specification. The classification model can be used to classify input text data to determine whether content of the input text data belongs to a category corresponding to the analysis basis information or a category to which the response result corresponding to the question data belongs.

In step S3086, the analysis basis information and the second response result that are included in the model prediction result are determined based on the category to which each piece of split text data belongs.

In implementation, after the category to which each piece of split text data belongs is determined by using the above-mentioned classification model, the analysis basis information and the second response result that are included in the model prediction result can be distinguished to determine which split text data in the model prediction result belongs to the analysis basis information and which split text data belongs to the second response result.

In step S3088, the authenticity evaluation result of the target model is determined based on the first response result, the analysis basis information, and the second response result.

In implementation, there can be various specific processing methods, and the following provides an optional processing method. The processing method specifically includes the following: The first response result is matched with the second response result (for a specific matching method, references can be made to the above-mentioned content). If the first response result matches the second response result, the first response result is matched with each piece of split text data that belongs to the category corresponding to the analysis basis information. If the first response result matches each piece of split text data that belongs to the category corresponding to the analysis basis information, it can be determined that the target model succeeds in authenticity evaluation, that is, it can be considered that the target model does not have a hallucination problem. If there is unmatched split text data or an amount of unmatched split text data exceeds a preset threshold, it can be determined that the target model fails in authenticity evaluation, that is, it can be considered that the target model has a hallucination problem. If the first response result does not match the second response result, it can be determined that the target model fails in authenticity evaluation, that is, it can be considered that the target model have a hallucination problem. The authenticity evaluation result of the target model can alternatively be determined in another method, which can be specifically set based on an actual situation.

In actual application, there can be various specific processing methods of step S3082. The following provides an optional processing method. The processing method specifically includes the following content: splitting processing is performed on the text data included in the model prediction result based on a position in which a punctuation mark is located and/or a position in which a preset line break is located, to obtain one or more pieces of different split text data.

The punctuation mark can include a period, a semicolon, a question mark, an exclamation mark, etc., and can be specifically set based on an actual situation. The line break can include “\n”, “\t”, “\r”, etc., and can be specifically set based on an actual situation.

In actual application, there can be various specific processing methods of step S3088, and the following provides an optional processing method. The processing method can specifically include the following step A2 to step A6.

In step A2, consistency check is performed between the first response result and the second response result to obtain a corresponding first check result.

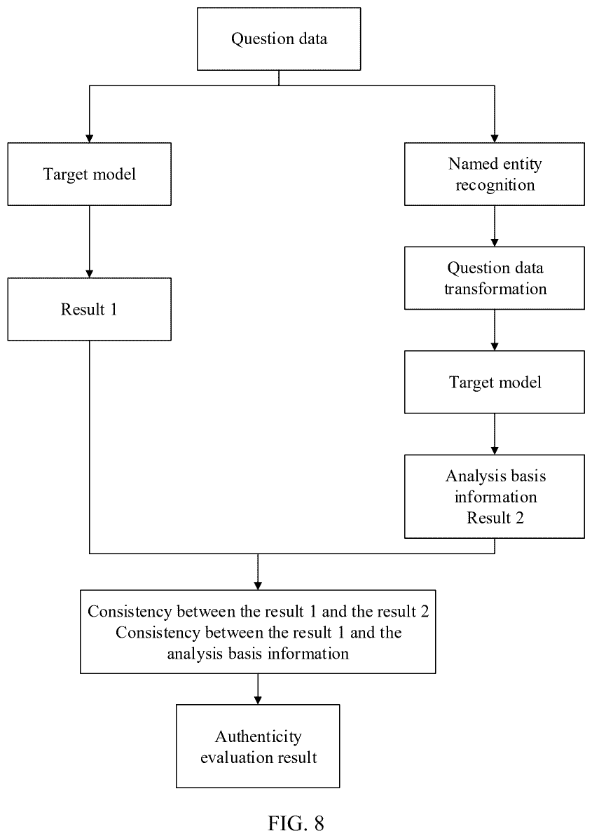

In implementation, as shown in FIG. 8, consistency check can be performed between the first response result and the second response result in a plurality of methods. For example, a consistency check algorithm can be preset, specifically, for example, an ICC intra-group correlation coefficient or a similarity algorithm. Consistency check can be performed between the first response result and the second response result by using the consistency algorithm, and an obtained calculation result is used as the first check result.

In step A4, consistency check is performed between the first response result and the analysis basis information to obtain a corresponding second check result.

In implementation, as shown in FIG. 8, consistency check can be performed between the first response result and the analysis basis information in a plurality of methods. For example, a consistency check algorithm between the first response result and the analysis basis information can be preset, specifically, for example, a similarity algorithm. Consistency check can be performed between the first response result and the analysis basis information by using the consistency algorithm, and an obtained calculation result is used as the second check result.

In step A6, the authenticity evaluation result of the target model is determined based on the first check result and the second check result.

In implementation, if both the first check result and the second check result indicate that the consistency check succeeds (that is, the first response result is consistent with the second response result, and the first response result is consistent with the analysis basis information), it can be determined that the target model succeeds in authenticity evaluation, that is, it can be considered that the target model does not have a hallucination problem. If at least one of the first check result and the second check result indicates that the consistency check fails (that is, the first response result is inconsistent with the second response result, and/or the first response result is inconsistent with the analysis basis information), it can be determined that the target model fails in authenticity evaluation, that is, it can be considered that the target model has a hallucination problem.

In actual application, there can be various specific processing methods of step A2, and the following provides an optional processing method. The processing method can specifically include the following step A22 and step A24.

In step A22, the first response result and the second response result are input to a first check model to obtain a consistency score between the first response result and the second response result.

The first check model can be constructed in a plurality of different methods. For example, the first check model can be constructed by using a neural network model, or can be constructed by using a similarity algorithm or a specified classification algorithm. A method can be specifically set based on an actual situation, and is not limited in the one or more embodiments of this specification. The first check model can be used to score consistency between different response results to determine whether different response results are consistent.

It is worthwhile to note that, before the first response result and the second response result are input to the first check model, a data pair, that is, a data pair of first response result-second response result, can be pre-constructed. For example, the first response result includes a result 11, a result 12, a result 13, a result 14, . . . , and a result 1m, where m is a positive integer greater than or equal to 1, and the second response result includes a result 21, a result 22, a result 23, a result 24, . . . , and a result 2q, where q is a positive integer greater than or equal to 1. In this case, the constructed data pair can include (result 1i, result 2j), where i=1, 2, 3, 4, . . . , and m, and j=1, 2, 3, 4, . . . , and q.

In step A24, the first check result is determined based on the consistency score between the first response result and the second response result.

In implementation, if the obtained consistency score is greater than the preset score threshold, it can be determined that the first check result is that the consistency check succeeds; or if the obtained consistency score is less than the preset score threshold, it can be determined that the first check result is that the consistency check fails. Alternatively, a conversion algorithm can be preset, and the obtained consistency score can be processed by using the conversion algorithm to obtain information that can directly represent the first check result. Alternatively, the first check result can be determined based on the obtained consistency score in another processing method, which can be specifically set based on an actual situation.

In actual application, there can be various specific processing methods of step A4, and the following provides an optional processing method. The processing method can specifically include the following step A42 to step A46.

In step A42, to-be-checked data is separately constructed by using the first response result and each piece of split text data that belongs to the analysis basis information.

In implementation, the to-be-checked data can be pre-constructed, and the to-be-checked data can be presented in a form of a data pair, that is, a data pair of first response result-split text data belonging to the analysis basis information. For example, the first response result includes a result 11, a result 12, a result 13, a result 14, . . . , and a result 1m, and the split text data belonging to the analysis basis information includes a basis 31, a basis 32, a basis 33, a basis 34, . . . , and a basis 3p, where p is a positive integer greater than or equal to 1. In this case, the constructed to-be-checked data can include (result 1i, basis 3k), where i=1, 2, 3, 4, . . . , and m, and k=1, 2, 3, 4, . . . , and p.

In step A44, each piece of to-be-checked data is input to a second check model to obtain a consistency score between the first response result and each piece of split text data that belongs to the analysis basis information.

The second check model can be constructed in a plurality of different methods. For example, the second check model can be constructed by using a neural network model, or can be constructed by using a similarity algorithm or a specified classification algorithm. A method can be specifically set based on an actual situation, and is not limited in the one or more embodiments of this specification. The second check model can be used to score consistency between the response result and the analysis basis information to determine whether the response result and the analysis basis information are consistent. The second check model can be the same as the first check model, or can be different from the first check model, which can be specifically set based on an actual situation.

In step A46, the second check result is determined based on the consistency score between the first response result and each piece of split text data that belongs to the analysis basis information.

In implementation, if a quantity of consistency scores greater than a preset score threshold exceeds a specified quantity threshold, it can be determined that the second check result is that the consistency check succeeds; or otherwise, it can be determined that the second check result is that the consistency check fails. Alternatively, a conversion algorithm can be preset, and the obtained consistency score can be processed by using the conversion algorithm to obtain information that can directly represent the second check result. Alternatively, the second check result can be determined based on the obtained consistency score in another processing method, which can be specifically set based on an actual situation.

In actual application, the target model is a large language model, the classification model is a model obtained by pre-training a BERT model in through supervised learning, the first check model is a model obtained by pre-training a BERT model in through supervised learning, and the second check model is a model obtained by pre-training a BERT model in through supervised learning.

When the classification model is a model obtained by pre-training a BERT model in through supervised learning, specific processing of step S3084 can include the following: The obtained split text data can be represented as text-1, text-2, text-3, . . . , and text-n, where n is a positive integer greater than or equal to 1. In this case, input data of the classification model (that is, the BERT model) can be [cls]text-t[sep], where t=1, 2, 3, 4, . . . , and n. After processing by using the BERT model, output data can be a corresponding score of [cls], and a category to which the split text data text-t belongs can be determined based on the corresponding score of the output data.

When the first check model is a model obtained by pre-training a BERT model in through supervised learning, specific processing of step A22 can include the following: Input data of the first check model (that is, the BERT model) can be a [cls] result 1i and a [sep] result 2j. After processing by using the BERT model, output data can be a corresponding score of [cls], that is, a consistency score between the result 1i and the result 2j, so that the consistency score between the first response result and the second response result can be obtained.

When the second check model is a model obtained by pre-training a BERT model in through supervised learning, specific processing of step A44 can include the following: Input data of the second check model (that is, the BERT model) can be a [cls] result 1i and a [sep] basis 3k. After processing by using the BERT model, output data can be a corresponding score of [cls], that is, a consistency score between the result 1i and the basis 3k, so that the consistency score between the first response result and each piece of split text data that belongs to the analysis basis information can be obtained.

The one or more embodiments of this specification provide a model authenticity evaluation method. First question data used to perform authenticity evaluation on a target model is obtained, and the first question data is input to the target model to obtain a first response result corresponding to the first question data. In addition, a named entity included in the first question data is extracted, and second question data is constructed based on the named entity and the first question data. Then, the second question data can be input to the target model to obtain a model prediction result corresponding to the second question data, where the model prediction result includes analysis basis information obtained by analyzing the first question data and a second response result corresponding to the first question data. Finally, an authenticity evaluation result of the target model can be determined based on the first response result and the model prediction result. In this way, the target model is used to check authenticity of the target model. For different query methods of same question data, if there is a contradiction between two results given by the target model, it can be determined that the target model has a hallucination. In addition, the solution does not depend on a pair of question-answer datasets. Therefore, any question data can be used as the first question data, so that it is easier to construct a dataset. Moreover, in the solution, the target model can be used to check itself, so that quality defects caused by a lack of a capability of a detection module do not occur, and poor detection quality caused by low quality of a question-answer dataset does not occur. Further, the solution does not depend on a discrete static dataset or depend on a data-driven detection tool (such as a knowledge graph or a retrieval tool), a so that a problem of sparse coverage scenarios does not occur. Moreover, the solution not only can be applied to an online real-time environment, but also can implement dynamic detection, thereby greatly improving efficiency and performance of model authenticity evaluation.

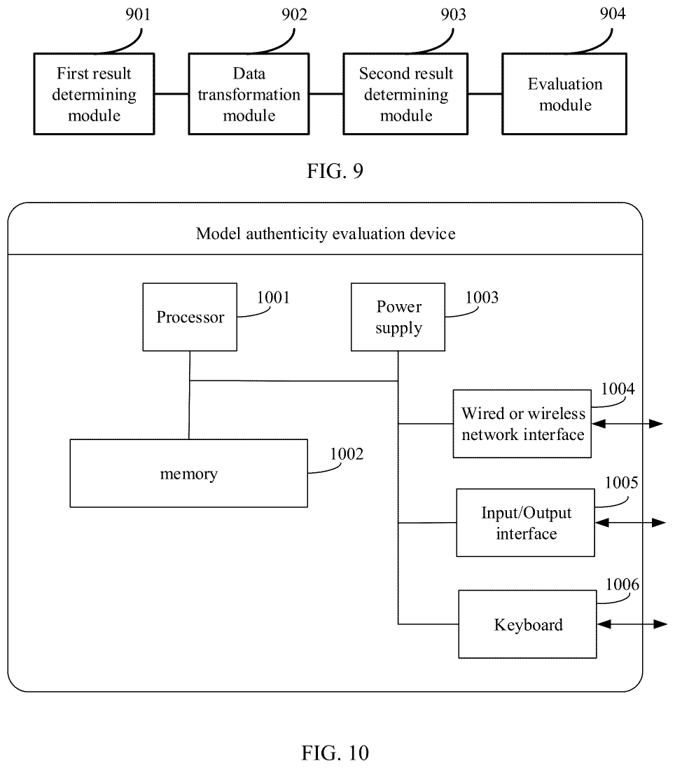

The model authenticity evaluation method provided in the embodiments of this specification are described above. Based on a same idea, one or more embodiments of this specification further provide a model authenticity evaluation apparatus, as shown in FIG. 9.

The model authenticity evaluation apparatus includes a first result determining module 901, a data transformation module 902, a second result determining module 903, and an evaluation module 904.

The first result determining module 901 obtains first question data used to perform authenticity evaluation on a target model, and inputs the first question data to the target model to obtain a first response result corresponding to the first question data.

The data transformation module 902 extracts a named entity included in the first question data, and constructs second question data based on the named entity and the first question data, where the second question data is used to trigger the target model to output an analysis basis and a result for the first question data.

The second result determining module 903 inputs the second question data to the target model to obtain a model prediction result corresponding to the second question data, where the model prediction result includes analysis basis information obtained by analyzing the first question data and a second response result corresponding to the first question data.

The evaluation module 904 determines an authenticity evaluation result of the target model based on the first response result and the model prediction result.

In the one or more embodiments of this specification, the data transformation module 902 includes:

a template acquisition unit, configured to obtain a preset question template; and

a question transformation unit, configured to replace corresponding to-be-replaced elements in the question template with the named entity and the first question data, and construct the second question data based on a replaced question template, where the second question data includes: please introduce each named entity included in the first question data, analyze the first question data, provide an analysis basis, and give an answer to the first question data.

In the one or more embodiments of this specification, the evaluation module 904 includes:

a splitting unit, configured to perform splitting processing on text data included in the model prediction result to obtain one or more pieces of different split text data;

a classification unit, configured to input each piece of split text data to a pre-trained classification model to obtain a category to which the piece of split text data belongs, where the category includes analysis basis information and a response result corresponding to question data;

a data determining unit, configured to determine, based on the category to which each piece of split text data belongs, the analysis basis information and the second response result that are included in the model prediction result; and

an evaluation unit, configured to determine the authenticity evaluation result of the target model based on the first response result, the analysis basis information, and the second response result.

In the one or more embodiments of this specification, the splitting unit performs splitting processing on the text data included in the model prediction result based on a position in which a punctuation mark is located and/or a position in which a preset line break is located, to obtain one or more pieces of different split text data.

In the one or more embodiments of this specification, the evaluation unit performs consistency check between the first response result and the second response result to obtain a corresponding first check result; and performs consistency check between the first response result and the analysis basis information to obtain a corresponding second check result; and determines the authenticity evaluation result of the target model based on the first check result and the second check result.

In the one or more embodiments of this specification, the evaluation unit inputs the first response result and the second response result to a first check model to obtain a consistency score between the first response result and the second response result; and determines the first check result based on the consistency score between the first response result and the second response result.

In the one or more embodiments of this specification, the evaluation unit separately constructs to-be-checked data by using the first response result and each piece of split text data that belongs to the analysis basis information; inputs each piece of to-be-checked data to a second check model to obtain a consistency score between the first response result and each piece of split text data that belongs to the analysis basis information; and determines the second check result based on the consistency score between the first response result and each piece of split text data that belongs to the analysis basis information.

In the one or more embodiments of this specification, the target model is a large language model, the classification model is a model obtained by pre-training a BERT model in through supervised learning, the first check model is a model obtained by pre-training a BERT model in through supervised learning, and the second check model is a model obtained by pre-training a BERT model in through supervised learning.

The one or more embodiments of this specification provide a model authenticity evaluation apparatus. First question data used to perform authenticity evaluation on a target model is obtained, and the first question data is input to the target model to obtain a first response result corresponding to the first question data. In addition, a named entity included in the first question data is extracted, and second question data is constructed based on the named entity and the first question data. Then, the second question data can be input to the target model to obtain a model prediction result corresponding to the second question data, where the model prediction result includes analysis basis information obtained by analyzing the first question data and a second response result corresponding to the first question data. Finally, an authenticity evaluation result of the target model can be determined based on the first response result and the model prediction result. In this way, the target model is used to check authenticity of the target model. For different query methods of same question data, if there is a contradiction between two results given by the target model, it can be determined that the target model has a hallucination. In addition, the solution does not depend on a pair of question-answer datasets. Therefore, any question data can be used as the first question data, so that it is easier to construct a dataset. Moreover, in the solution, the target model can be used to check itself, so that quality defects caused by a lack of a capability of a detection module do not occur, and poor detection quality caused by low quality of a question-answer dataset does not occur. Further, the solution does not depend on a discrete static dataset or depend on a data-driven detection tool (such as a knowledge graph or a retrieval tool), a so that a problem of sparse coverage scenarios does not occur. Moreover, the solution not only can be applied to an online real-time environment, but also can implement dynamic detection, thereby greatly improving efficiency and performance of model authenticity evaluation.

The model authenticity evaluation apparatus provided in the embodiments of this specification is described above. Based on a same idea, one or more embodiments of this specification further provide a model authenticity evaluation device, as shown in FIG. 10.

The model authenticity evaluation device can be a terminal device, a server, etc. provided in the above-mentioned embodiments.

The model authenticity evaluation device can vary greatly based on configuration or performance, and can include one or more processors 1001 and a memory 1002. The memory 1002 can store one or more storage applications or data. The memory 1002 can be a transient storage or a persistent storage. The application stored in the memory 1002 can include one or more modules (not shown in the figure), and each module can include a series of computer-executable instructions in the model authenticity assessment device. Further, the processor 1001 can be configured to communicate with the memory 1002, and execute a series of computer-executable instructions in the memory 1002 on the model authenticity assessment device. The model authenticity assessment device can further include one or more power supplies 1003, one or more wired or wireless network interfaces 1004, one or more input/output interfaces 1005, one or more keyboards 1006, etc.

Specifically, in the one or more embodiments, the model authenticity assessment device includes a memory and one or more programs. The one or more programs are stored in the memory, and the one or more programs can include one or more modules, and each module can include a series of computer-executable instructions in the model authenticity assessment device. The one or more processors are configured to execute the computer-executable instructions included in the one or more programs to perform the following operations:

obtaining first question data used to perform authenticity evaluation on a target model, and inputting the first question data to the target model to obtain a first response result corresponding to the first question data;

extracting a named entity included in the first question data, and constructing second question data based on the named entity and the first question data, where the second question data is used to trigger the target model to output an analysis basis and a result for the first question data;

inputting the second question data to the target model to obtain a model prediction result corresponding to the second question data, where the model prediction result includes analysis basis information obtained by analyzing the first question data and a second response result corresponding to the first question data; and

determining an authenticity evaluation result of the target model based on the first response result and the model prediction result.

The embodiments of this specification are described in a progressive way. For same or similar parts in the embodiments, references can be made to each other. Each embodiment focuses on a difference from another embodiment. Particularly, the embodiments of the model authenticity assessment device are basically similar to the method embodiments, and therefore are described briefly. For related parts, references can be made to related descriptions in the method embodiments.

The one or more embodiments of this specification provide a model authenticity evaluation device. First question data used to perform authenticity evaluation on a target model is obtained, and the first question data is input to the target model to obtain a first response result corresponding to the first question data. In addition, a named entity included in the first question data is extracted, and second question data is constructed based on the named entity and the first question data. Then, the second question data can be input to the target model to obtain a model prediction result corresponding to the second question data, where the model prediction result includes analysis basis information obtained by analyzing the first question data and a second response result corresponding to the first question data. Finally, an authenticity evaluation result of the target model can be determined based on the first response result and the model prediction result. In this way, the target model is used to check authenticity of the target model. For different query methods of same question data, if there is a contradiction between two results given by the target model, it can be determined that the target model has a hallucination. In addition, the solution does not depend on a pair of question-answer datasets. Therefore, any question data can be used as the first question data, so that it is easier to construct a dataset. Moreover, in the solution, the target model can be used to check itself, so that quality defects caused by a lack of a capability of a detection module do not occur, and poor detection quality caused by low quality of a question-answer dataset does not occur. Further, the solution does not depend on a discrete static dataset or depend on a data-driven detection tool (such as a knowledge graph or a retrieval tool), a so that a problem of sparse coverage scenarios does not occur. Moreover, the solution not only can be applied to an online real-time environment, but also can implement dynamic detection, thereby greatly improving efficiency and performance of model authenticity evaluation.

Further, based on the method shown in FIG. 3 to FIG. 8, one or more embodiments of this specification further provide a storage medium, configured to store computer-executable instruction information. In a specific embodiment, the storage medium can be a USB flash drive, an optical disc, a hard disk, etc. When the computer-executable instruction information stored in the storage medium is executed by a processor, the following procedure can be implemented:

obtaining first question data used to perform authenticity evaluation on a target model, and inputting the first question data to the target model to obtain a first response result corresponding to the first question data;

extracting a named entity included in the first question data, and constructing second question data based on the named entity and the first question data, where the second question data is used to trigger the target model to output an analysis basis and a result for the first question data;

inputting the second question data to the target model to obtain a model prediction result corresponding to the second question data, where the model prediction result includes analysis basis information obtained by analyzing the first question data and a second response result corresponding to the first question data; and

determining an authenticity evaluation result of the target model based on the first response result and the model prediction result.

The embodiments of this specification are described in a progressive way. For same or similar parts in the embodiments, references can be made to each other. Each embodiment focuses on a difference from another embodiment. Particularly, the above-mentioned storage medium embodiments are basically similar to the method embodiments, and therefore are described briefly. For related parts, references can be made to related descriptions in the method embodiments.

The one or more embodiments of this specification provide a storage medium. First question data used to perform authenticity evaluation on a target model is obtained, and the first question data is input to the target model to obtain a first response result corresponding to the first question data. In addition, a named entity included in the first question data is extracted, and second question data is constructed based on the named entity and the first question data. Then, the second question data can be input to the target model to obtain a model prediction result corresponding to the second question data, where the model prediction result includes analysis basis information obtained by analyzing the first question data and a second response result corresponding to the first question data. Finally, an authenticity evaluation result of the target model can be determined based on the first response result and the model prediction result. In this way, the target model is used to check authenticity of the target model. For different query methods of same question data, if there is a contradiction between two results given by the target model, it can be determined that the target model has a hallucination. In addition, the solution does not depend on a pair of question-answer datasets. Therefore, any question data can be used as the first question data, so that it is easier to construct a dataset. Moreover, in the solution, the target model can be used to check itself, so that quality defects caused by a lack of a capability of a detection module do not occur, and poor detection quality caused by low quality of a question-answer dataset does not occur. Further, the solution does not depend on a discrete static dataset or depend on a data-driven detection tool (such as a knowledge graph or a retrieval tool), a so that a problem of sparse coverage scenarios does not occur. Moreover, the solution not only can be applied to an online real-time environment, but also can implement dynamic detection, thereby greatly improving efficiency and performance of model authenticity evaluation.

Further, based on the method shown in FIG. 3 to FIG. 8, one or more embodiments of this specification further provide a computer program product, including a computer program. When the computer program in the computer program product is executed by a processor, the following procedure can be implemented:

obtaining first question data used to perform authenticity evaluation on a target model, and inputting the first question data to the target model to obtain a first response result corresponding to the first question data;

extracting a named entity included in the first question data, and constructing second question data based on the named entity and the first question data, where the second question data is used to trigger the target model to output an analysis basis and a result for the first question data;

inputting the second question data to the target model to obtain a model prediction result corresponding to the second question data, where the model prediction result includes analysis basis information obtained by analyzing the first question data and a second response result corresponding to the first question data; and

determining an authenticity evaluation result of the target model based on the first response result and the model prediction result.

The embodiments of this specification are described in a progressive way. For same or similar parts in the embodiments, references can be made to each other. Each embodiment focuses on a difference from another embodiment. Particularly, the above-mentioned computer program product embodiments are basically similar to the method embodiments, and therefore are described briefly. For related parts, references can be made to related descriptions in the method embodiments.

The one or more embodiments of this specification provide a computer program product. First question data used to perform authenticity evaluation on a target model is obtained, and the first question data is input to the target model to obtain a first response result corresponding to the first question data. In addition, a named entity included in the first question data is extracted, and second question data is constructed based on the named entity and the first question data. Then, the second question data can be input to the target model to obtain a model prediction result corresponding to the second question data, where the model prediction result includes analysis basis information obtained by analyzing the first question data and a second response result corresponding to the first question data. Finally, an authenticity evaluation result of the target model can be determined based on the first response result and the model prediction result. In this way, the target model is used to check authenticity of the target model. For different query methods of same question data, if there is a contradiction between two results given by the target model, it can be determined that the target model has a hallucination. In addition, the solution does not depend on a pair of question-answer datasets. Therefore, any question data can be used as the first question data, so that it is easier to construct a dataset. Moreover, in the solution, the target model can be used to check itself, so that quality defects caused by a lack of a capability of a detection module do not occur, and poor detection quality caused by low quality of a question-answer dataset does not occur. Further, the solution does not depend on a discrete static dataset or depend on a data-driven detection tool (such as a knowledge graph or a retrieval tool), a so that a problem of sparse coverage scenarios does not occur. Moreover, the solution not only can be applied to an online real-time environment, but also can implement dynamic detection, thereby greatly improving efficiency and performance of model authenticity evaluation.

Specific embodiments of this specification are described above. Other embodiments fall within the scope of the appended claims. In some cases, actions or steps described in the claims can be performed in an order different from that in the embodiments and desired results can still be achieved. In addition, the processes depicted in the accompanying drawings do not necessarily need a specific order or a sequential order to achieve the desired results. In some implementations, multitasking and concurrent processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using some of the above-mentioned described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor.

Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively, the apparatus configured to implement various functions can be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a computer. Specifically, for example, the computer can be a personal computer, a laptop computer, a cellular phone, a camera phone, a smartphone, a personal digital assistant, a media player, a navigation device, an e-mail device, a game console, a tablet computer, a wearable device, or any combination of these devices.

For ease of description, the above-mentioned apparatus is divided into various units based on functions for separate description. Certainly, during implementation of one or more embodiments of this specification, the functions of each unit can be implemented in one or more pieces of software and/or hardware.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, one or more embodiments of this specification can use a form of a computer program product that is implemented on one or more computer-usable storage media (including but not limited to a disk memory, a CD-ROM, an optical memory, etc.) that include computer-usable program code.

The embodiments of this specification are described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable memory that can instruct a computer or another programmable data processing device to work in a specific way, so that the instructions stored in the computer-readable memory generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory can include a non-persistent memory, a random access memory (RAM), a nonvolatile memory, and/or another form in a computer-readable medium, for example, a read-only memory (ROM) or a flash memory (flash RAM). The memory is an example of the computer-readable medium.

Computer-readable media, including permanent and non-permanent, removable and non-removable media, can implement information storage by any method or technology. The information can be a computer-readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by the computing device. Based on the definition in this specification, the computer-readable medium does not include transitory media such as a modulated data signal and carrier.

It is worthwhile to further note that the terms “include”, “comprise”, or any other variants thereof are intended to cover a non-exclusive inclusion, so that a process, method, product, or device that includes a list of elements not only includes those elements but also includes other elements which are not expressly listed, or further includes elements inherent to such a process, method, product, or device. Without more constraints, an element preceded by “includes a . . . ” does not exclude the existence of additional identical elements in the process, method, product or device that includes the element.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, one or more embodiments of this specification can use a form of a computer program product that is implemented on one or more computer-usable storage media (including but not limited to a disk memory, a CD-ROM, an optical memory, etc.) that include computer-usable program code.

One or more embodiments of this specification can be described in the general context of computer-executable instructions, for example, a program module. Generally, the program module includes a routine, a program, an object, a component, a data structure, etc. executing a specific task or implementing a specific abstract data type. Alternatively, the one or more embodiments of this specification can be practiced in distributed computing environments. In the distributed computing environments, tasks are executed by remote processing devices connected by using a communication network. In the distributed computing environments, the program module can be located in a local and remote computer storage medium including a storage device.

The embodiments of this specification are described in a progressive way. For same or similar parts in the embodiments, references can be made to each other. Each embodiment focuses on a difference from another embodiment. Particularly, the system embodiments are basically similar to the method embodiments, and therefore are described briefly. For related parts, references can be made to related descriptions in the method embodiments.

The above-mentioned descriptions are merely embodiments of this specification, and are not intended to limit this specification. A person skilled in the art can make various changes and variations to this specification. Any modifications, equivalent replacements, improvements, etc. made without departing from the spirit and principle of this specification shall fall within the scope of the claims of this specification.

1. A model authenticity evaluation method, wherein the method comprises:
obtaining first question data used to perform authenticity evaluation on a target model, and inputting the first question data to the target model to obtain a first response result corresponding to the first question data;
extracting a named entity comprised in the first question data, and constructing second question data based on the named entity and the first question data, wherein the second question data is used to trigger the target model to output an analysis basis and a result for the first question data;
inputting the second question data to the target model to obtain a model prediction result corresponding to the second question data, wherein the model prediction result comprises analysis basis information obtained by analyzing the first question data and a second response result corresponding to the first question data; and
determining an authenticity evaluation result of the target model based on the first response result and the model prediction result.

2. The method according to claim 1, wherein constructing the second question data based on the named entity and the first question data comprises:
obtaining a preset question template; and
replacing corresponding to-be-replaced elements in the question template with the named entity and the first question data, and constructing the second question data based on a replaced question template, wherein the second question data comprises: please introduce each named entity comprised in the first question data, analyze the first question data, provide an analysis basis, and give an answer to the first question data.

3. The method according to claim 1, wherein determining the authenticity evaluation result of the target model based on the first response result and the model prediction result comprises:
performing splitting processing on text data comprised in the model prediction result to obtain one or more pieces of different split text data;
inputting each piece of split text data to a pre-trained classification model to obtain a category to which the piece of split text data belongs, wherein the category comprises analysis basis information and a response result corresponding to question data;
determining, based on the category to which each piece of split text data belongs, the analysis basis information and the second response result that are comprised in the model prediction result; and
determining the authenticity evaluation result of the target model based on the first response result, the analysis basis information, and the second response result.

4. The method according to claim 3, wherein performing the splitting processing on text data comprised in the model prediction result to obtain one or more pieces of different split text data comprises:
performing splitting processing on the text data comprised in the model prediction result based on a position in which a punctuation mark is located and/or a position in which a preset line break is located, to obtain one or more pieces of different split text data.

5. The method according to claim 3, wherein determining the authenticity evaluation result of the target model based on the first response result, the analysis basis information, and the second response result comprises:
performing consistency check between the first response result and the second response result to obtain a corresponding first check result;
performing consistency check between the first response result and the analysis basis information to obtain a corresponding second check result; and
determining the authenticity evaluation result of the target model based on the first check result and the second check result.

6. The method according to claim 5, wherein performing the consistency check between the first response result and the second response result to obtain a corresponding first check result comprises:
inputting the first response result and the second response result to a first check model to obtain a consistency score between the first response result and the second response result; and
determining the first check result based on the consistency score between the first response result and the second response result.

7. The method according to claim 6, wherein performing the consistency check between the first response result and the analysis basis information to obtain a corresponding second check result comprises:
separately constructing to-be-checked data by using the first response result and each piece of split text data that belongs to the analysis basis information;
inputting each piece of to-be-checked data to a second check model to obtain a consistency score between the first response result and each piece of split text data that belongs to the analysis basis information; and
determining the second check result based on the consistency score between the first response result and each piece of split text data that belongs to the analysis basis information.

8. The method according to claim 7, wherein the target model is a large language model, the classification model is a model obtained by pre-training a BERT model in through supervised learning, the first check model is a model obtained by pre-training a BERT model in through supervised learning, and the second check model is a model obtained by pre-training a BERT model in through supervised learning.

9. A model authenticity evaluation device, wherein the model authenticity evaluation device comprises:
a processor; and
a memory, configured to store computer-executable instructions, wherein when the executable instructions are executed, the processor is caused to:
obtain first question data used to perform authenticity evaluation on a target model, and input the first question data to the target model to obtain a first response result corresponding to the first question data;
extract a named entity comprised in the first question data, and construct second question data based on the named entity and the first question data, wherein the second question data is used to trigger the target model to output an analysis basis and a result for the first question data;
input the second question data to the target model to obtain a model prediction result corresponding to the second question data, wherein the model prediction result comprises analysis basis information obtained by analyzing the first question data and a second response result corresponding to the first question data; and
determine an authenticity evaluation result of the target model based on the first response result and the model prediction result.

10. The model authenticity evaluation device according to claim 9, wherein the processor being caused to construct the second question data based on the named entity and the first question data comprises being caused to:
obtain a preset question template; and
replace corresponding to-be-replaced elements in the question template with the named entity and the first question data, and construct the second question data based on a replaced question template, wherein the second question data comprises: please introduce each named entity comprised in the first question data, analyze the first question data, provide an analysis basis, and give an answer to the first question data.

11. The model authenticity evaluation device according to claim 9, wherein the processor being caused to determine the authenticity evaluation result of the target model based on the first response result and the model prediction result comprises being caused to:
perform splitting processing on text data comprised in the model prediction result to obtain one or more pieces of different split text data;
input each piece of split text data to a pre-trained classification model to obtain a category to which the piece of split text data belongs, wherein the category comprises analysis basis information and a response result corresponding to question data;
determine, based on the category to which each piece of split text data belongs, the analysis basis information and the second response result that are comprised in the model prediction result; and
determine the authenticity evaluation result of the target model based on the first response result, the analysis basis information, and the second response result.

12. The model authenticity evaluation device according to claim 11, wherein the processor being caused to perform the splitting processing on text data comprised in the model prediction result to obtain one or more pieces of different split text data comprises being caused to:
perform splitting processing on the text data comprised in the model prediction result based on a position in which a punctuation mark is located and/or a position in which a preset line break is located, to obtain one or more pieces of different split text data.

13. The model authenticity evaluation device according to claim 11, wherein the processor being caused to determine the authenticity evaluation result of the target model based on the first response result, the analysis basis information, and the second response result comprises being caused to:
perform consistency check between the first response result and the second response result to obtain a corresponding first check result;
perform consistency check between the first response result and the analysis basis information to obtain a corresponding second check result; and
determine the authenticity evaluation result of the target model based on the first check result and the second check result.

14. The model authenticity evaluation device according to claim 13, wherein the processor being caused to perform the consistency check between the first response result and the second response result to obtain a corresponding first check result comprises being caused to:
input the first response result and the second response result to a first check model to obtain a consistency score between the first response result and the second response result; and
determine the first check result based on the consistency score between the first response result and the second response result.

15. The model authenticity evaluation device according to claim 14, wherein the processor being caused to perform the consistency check between the first response result and the analysis basis information to obtain a corresponding second check result comprises being caused to:
separately construct to-be-checked data by using the first response result and each piece of split text data that belongs to the analysis basis information;
input each piece of to-be-checked data to a second check model to obtain a consistency score between the first response result and each piece of split text data that belongs to the analysis basis information; and
determine the second check result based on the consistency score between the first response result and each piece of split text data that belongs to the analysis basis information.

16. The model authenticity evaluation device according to claim 15, wherein the target model is a large language model, the classification model is a model obtained by pre-training a BERT model in through supervised learning, the first check model is a model obtained by pre-training a BERT model in through supervised learning, and the second check model is a model obtained by pre-training a BERT model in through supervised learning.

17. A non-transitory computer-readable storage medium, wherein the non-transitory computer-readable storage medium stores a computer program, which when executed by a processor causes the processor to:
obtain first question data used to perform authenticity evaluation on a target model, and input the first question data to the target model to obtain a first response result corresponding to the first question data;
extract a named entity comprised in the first question data, and construct second question data based on the named entity and the first question data, wherein the second question data is used to trigger the target model to output an analysis basis and a result for the first question data;
input the second question data to the target model to obtain a model prediction result corresponding to the second question data, wherein the model prediction result comprises analysis basis information obtained by analyzing the first question data and a second response result corresponding to the first question data; and
determine an authenticity evaluation result of the target model based on the first response result and the model prediction result.

18. The non-transitory computer-readable storage medium according to claim 17, wherein the processor being caused to construct the second question data based on the named entity and the first question data comprises being caused to:
obtain a preset question template; and
replace corresponding to-be-replaced elements in the question template with the named entity and the first question data, and construct the second question data based on a replaced question template, wherein the second question data comprises: please introduce each named entity comprised in the first question data, analyze the first question data, provide an analysis basis, and give an answer to the first question data.

19. The non-transitory computer-readable storage medium according to claim 17, wherein the processor being caused to determine the authenticity evaluation result of the target model based on the first response result and the model prediction result comprises being caused to:
perform splitting processing on text data comprised in the model prediction result to obtain one or more pieces of different split text data;
input each piece of split text data to a pre-trained classification model to obtain a category to which the piece of split text data belongs, wherein the category comprises analysis basis information and a response result corresponding to question data;
determine, based on the category to which each piece of split text data belongs, the analysis basis information and the second response result that are comprised in the model prediction result; and
determine the authenticity evaluation result of the target model based on the first response result, the analysis basis information, and the second response result.

20. The non-transitory computer-readable storage medium according to claim 19, wherein the processor being caused to perform the splitting processing on text data comprised in the model prediction result to obtain one or more pieces of different split text data comprises being caused to:
perform splitting processing on the text data comprised in the model prediction result based on a position in which a punctuation mark is located and/or a position in which a preset line break is located, to obtain one or more pieces of different split text data.
